(19) United States
(12) Patent Application Publication
(10) Pub. No.: US 2021/0241406 A1
(43) Pub. Date: Aug. 5, 2021

(54) MANAGEMENT DEVICE, MANAGEMENT METHOD, AND MANAGEMENT PROGRAM

(71) Applicant: NIPPON TELEGRAPH AND TELEPHONE CORPORATION, Tokyo (JP)

(72) Inventors: Shinya TAKADA, Musashino-shi, Tokyo (JP); Junko HASHIMOTO, Musashino-shi, Tokyo (JP); Koji KISHI, Musashino-shi, Tokyo (JP); Yoshihiro YOSHIDA, Musashino-shi, Tokyo (JP); Tsuneko KURA, Musashino-shi, Tokyo (JP); Akira KOYAMA, Musashino-shi, Tokyo (JP)

(73) Assignee: NIPPON TELEGRAPH AND TELEPHONE CORPORATION, Tokyo (JP)

(21) Appl. No.: 17/053,832

(22) PCT Filed: May 9, 2019
(86) PCT No.: PCT/JP2019/018625

§ 371 Date: Nov. 9, 2020

(30) Foreign Application Priority Data
May 11, 2018 (JP) 2018-092528

(51) Int. Cl. G06Q 50/26; G06F 16/954; G08B 25/01

(52) U.S. Cl. CPC G06Q 50/265; G08B 25/016; G06F 16/954

(57) ABSTRACT

A management device (10) includes a mission pack acquisition unit (12a), a process set acquisition unit (12b), and an integration unit (12c). The mission pack acquisition unit (12a) acquires a mission pack associated with a set of check items to be implemented during crisis response and association between a process indicating a phase of a critical event and the mission pack. The process set acquisition unit (12b) acquires a process set associated with a set of processes. The integration unit (12c) integrates, for each process set, association among the process, the mission pack, and the check items as integrated information (11d).

### TECHNICAL FIELD

The present invention relates to a management device, a management method, and a management program.

### BACKGROUND ART

Conventionally, WebEOC (registered trademark) has been known as a crisis response system for managing processes dealing with crisis, for example, disasters such as fire, earthquake, and flooding and incidents such as cyberterrorism. For example, development of an integrated risk management system capable of executing information aggregation, consideration, and command between cyberattacks and disaster accidents in real world in a unified manner has been proposed (see Non Patent Literature 1).

WebEOC converts information on disaster response shared by whiteboards, e-mails, telephones, and facsimiles at an emergency operations center (EOC) into Web, aggregates, manages, and shares information among all departments and organizations responsible for disaster response to implement a common operational picture (COP) and supports efficient operations of the emergency operations center.

As a system constructed based on WebEOC, a system for implementing a COP by a Plan screen for presenting processes at headquarters and implementation items in each phase, a Do screen for managing information on the degrees of importance and the progress of non-routine tasks, and a See screen for displaying measures and damage situations in the form of maps and tables in perspective view has been known.

A plurality of organizations deal with crisis and are responsible for different handling tasks. In other words, processes for crisis response are different between processes for persons of field class who deal with crisis at the site and processes for persons of management class who manage situation reports. Each organization determines measures and strategies in accordance with individual processes, and deals with crisis in accordance with the determined measures and strategies.

The process defines what should be done and what should be checked in a phase of a critical event, and corresponds to one or more check items. The check item is indicated as, for example, an action “Share vulnerability information among organizations as needed”.

A crisis response system, which is used by persons in various positions, needs to present a set of processes suited for a corresponding position as a process set. Presenting a set of actions and checks for dealing with crisis as a process set corresponds to “Planning P”, which is a management process for crisis response based on International Standard ISO 22320. In the crisis response system, it is important to flexibly define association among individual check items, processes, and a process set to deal with crisis.

### CITATION LIST

### Non Patent Literature

[NPL 1] Tomohiro Kokogawa, and five others, “Efforts to Achieve a Joint Risk Management Support System”, [online], October 2015, NIPPON TELEGRAPH AND TELEPHONE CORPORATION, NTT Technical Review 2015.10, [searched on Apr. 5, 2018], Internet <URL:http://www.ntt.co.jp/journal/1510/files/jn201510027.pdf>

### SUMMARY OF THE INVENTION

### Technical Problem

In the conventional technology, however, it is difficult to flexibly deal with crisis. For example, a process and check items are directly associated with each other and managed, and hence the degree of freedom of combination is low, and individual check items need to be managed for each process, which is complicated.

One process set can be treated as a target of “Planning P”, and the state of change in the process set can be managed along only one time axis. Thus, even when there are a plurality of process sets to be executed concurrently, the process sets cannot be managed by switching, and it is difficult to manage the implementation of various kinds of handling to be executed for crisis.

The present invention has been made in view of the above, and it is an object thereof to facilitate management between a process for crisis response and check items corresponding to the process and enable flexible response to crisis.

### Means for Solving the Problem

In order to solve the above-mentioned problems and achieve the object, a management device according to the present invention includes: a mission pack acquisition unit that acquires a mission pack associated with a set of check items to be implemented during crisis response and association between a process indicating a phase of a critical event and the mission pack; a process set acquisition unit that acquires a process set associated with a set of the processes; and an integration unit that integrates, for each process set, association among the process, the mission pack, and the check items as integrated information.

### Effects of the Invention

According to the present invention, the management between a process for crisis response and check items corresponding to the process can be facilitated to enable flexible response to crisis.

### BRIEF DESCRIPTION OF DRAWINGS

FIG. 1 is an explanatory diagram for describing the outline of a crisis response system.

FIG. 2 is a schematic diagram exemplifying a schematic configuration of a management device according to this embodiment.

FIG. 3 is a diagram exemplifying a data configuration of process information.

FIG. 4 is a diagram exemplifying a data configuration of mission pack information.

FIG. 5 is an explanatory diagram for describing processing of a mission pack acquisition unit.

FIG. 6 is a diagram exemplifying a data configuration of process set information.

FIG. 7 is an explanatory diagram for describing processing of a process set acquisition unit.

FIG. 8 is a diagram exemplifying a data configuration of integrated information.

FIG. 9 is an explanatory diagram for describing processing of a current process acquisition unit.

FIG. 10 is an explanatory diagram for describing processing of a disclosure unit.

FIG. 11 is a flowchart illustrating a management processing procedure.

FIG. 12 is a diagram illustrating an example of a computer for executing a management program.

### DESCRIPTION OF EMBODIMENTS

One embodiment of the present invention is described in detail below with reference to the drawings. Note that the present invention is not limited by the embodiment. In the drawings, the same parts are denoted by the same reference symbols.

[Outline of Crisis Response System]

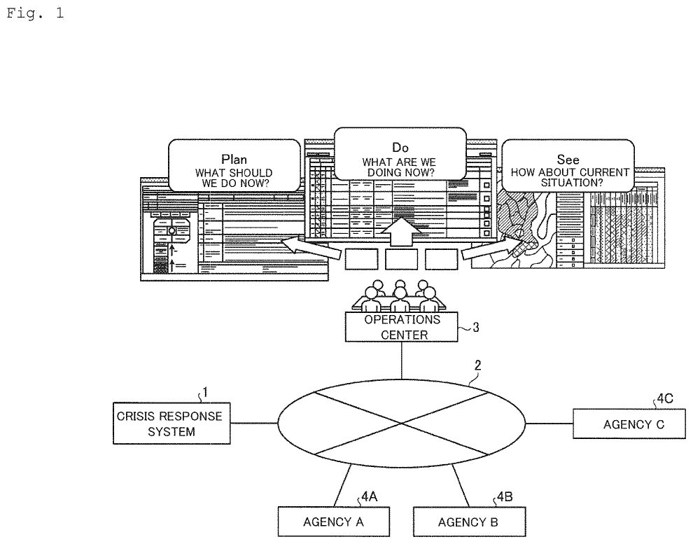

A management device in the present invention may be implemented as a device included in a crisis response system or one function of the crisis response system. First, the crisis response system is described with reference to FIG. 1. FIG. 1 is an explanatory diagram for describing the outline of the crisis response system.

As illustrated in FIG. 1, a crisis response system 1 is connected to an operations center 3 and a plurality of organizations such as a plurality of agencies 4A, 4B, and 4C through a network 2. The network 2 only needs to be configured such that connected devices can communicate with one another, and can be configured by the Internet, a local area network (LAN), or a wide area network (WAN). Note that, in the following, the plurality of agencies 4A, 4B, and 4C are referred to as “agencies 4” unless otherwise distinguished. In the example in FIG. 1, three agencies 4 appear as the plurality of agencies 4, but the number of the agencies 4 is not limited thereto and may be two or less and four or more.

The operations center 3 and the agencies 4 are each provided with a client terminal such as a personal computer and a smartphone, and a user can refer to information provided from the crisis response system 1 and transmit information to the crisis response system 1 through a Web browser on each client terminal.

The crisis response system 1 displays, on the client terminals provided to the operations center 3 and the agencies 4A, 4B, and 4C, a Plan screen for presenting processes at headquarters and implementation items in each phase, a Do screen for managing information on the degrees of importance and the progress of non-routine tasks, and a See screen for displaying measures and damage situations in the form of maps and tables in perspective view. Note that the management device in the present invention provides functions related to the Plan screen and the See screen, in particular.

[Configuration of Management Device]

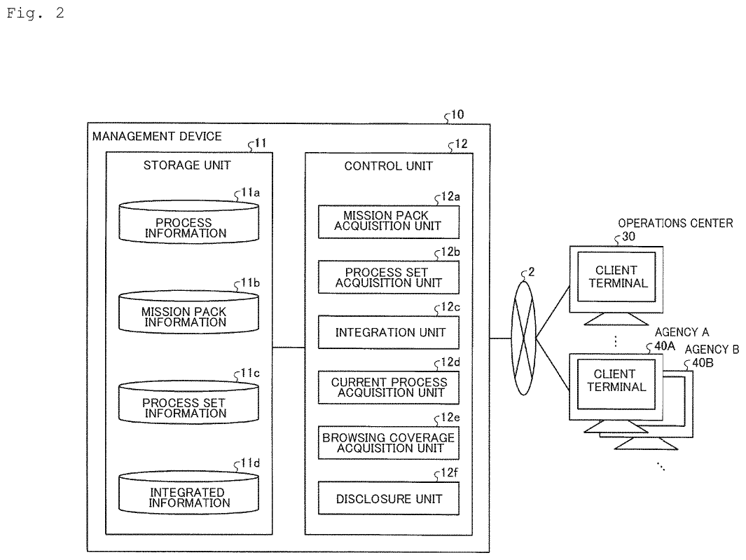

FIG. 2 is a schematic diagram exemplifying a schematic configuration of a management device according to this embodiment. As illustrated in FIG. 2, a management device 10 is connected to a client terminal 30 in an operations center 3 and client terminals 40A and 40B in agencies A and B by a network 2 capable of data connection. Note that, in the following, the plurality of client terminals 40A and 40B are referred to as “client terminals 40” unless otherwise distinguished.

The management device 10 is implemented by a general-purpose computer such as a server device, and includes a storage unit 11 and a control unit 12 as illustrated in FIG. 2.

The storage unit 11 is implemented by a storage device, for example, a semiconductor memory element such as a random access memory (RAM) or a flash memory, a hard disk, or an optical disc. In this embodiment, process information 11a, mission pack information 11b, process set information 11c, and integrated information 11d are stored in the storage unit 11. Specific contents of the information stored in the storage unit 11 are successively described in the following descriptions of functions of units in the control unit 12.

The control unit 12 is implemented by using an electronic circuit such as a central processing unit (CPU) or a micro processing unit (MPU) or an integrated circuit such as an application specific integrated circuit (ASIC) or a field programmable gate array (FPGA). The control unit 12 executes a processing program stored in a memory to function as a mission pack acquisition unit 12a, a process set acquisition unit 12b, an integration unit 12c, a current process acquisition unit 12d, a browsing coverage acquisition unit 12e, and a disclosure unit 12f as exemplified in FIG. 1. Note that the whole or part of these functional units may be mounted on different pieces of hardware.

The mission pack acquisition unit 12a acquires a mission pack associated with a set of check items to be implemented during crisis response and association between a process indicating a phase of a critical event and the mission pack. Specifically, the mission pack acquisition unit 12a acquires process information 11a and mission pack information 11b, and stores the process information 11a and the mission pack information 11b in the storage unit 11. For example, the mission pack acquisition unit 12a receives input of process information and mission pack information generated in advance from an operator or another device such as the client terminals 30 and 40, and stores the process information and the mission pack information in the storage unit 11.

Alternatively, the process information 11a and the mission pack information 11b may be automatically generated. For example, the management device 10 may store templates of process information and mission packs in the storage unit 11, and the mission pack acquisition unit 12a may generate the process information 11a and the mission pack information 11b on the basis of the templates when starting to plan a crisis response.

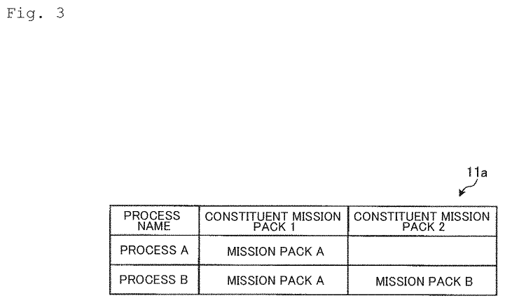

FIG. 3 is a diagram exemplifying a data configuration of the process information 11a. As illustrated in FIG. 3, the process information 11a is information indicating association between a process and a mission pack. In FIG. 3, a process name indicates the name of a process. Constituent mission packs 1, 2, . . . indicate the names of mission packs associated with each process. In the example illustrated in FIG. 3, for example, a process “process B” is associated with a mission pack “mission pack A” and a “mission pack B”.

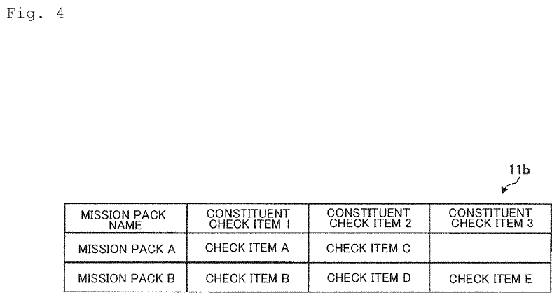

FIG. 4 is a diagram exemplifying a data configuration of the mission pack information 11b. As illustrated in FIG. 4, the mission pack information 11b is information indicating a mission pack associated with a set of check items, and is indicated by association between a mission pack and check items. In FIG. 4, a mission pack name indicates the name of a mission pack. Constituent check items 1, 2, . . . indicate the names of check items associated with each mission pack. In the example illustrated in FIG. 4, for example, a mission pack “mission pack A” is associated with a check item “check item A” and a “check item C”.

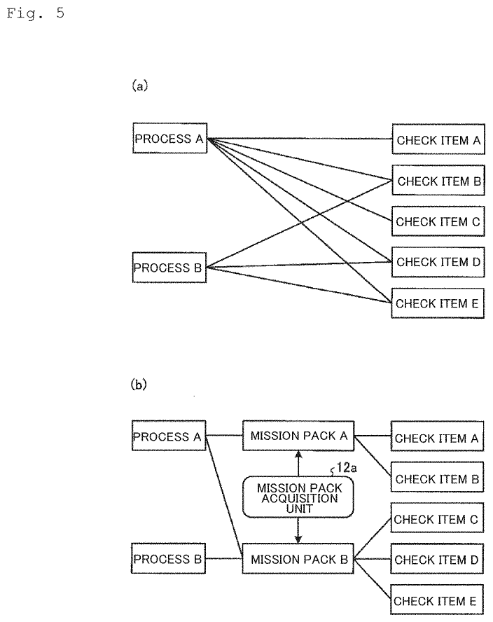

FIG. 5 are explanatory diagrams for describing processing of the mission pack acquisition unit 12a.

Conventionally, a process and check items are directly associated with each other and managed as illustrated in FIG. 5(a). Thus, there may be check items that are redundantly associated with different processes such as a check item B, a check item D, and a check item E illustrated in FIG. 5(a), and the management is complicated.

As illustrated in FIG. 5(b), on the other hand, the process information 11a and the mission pack information 11b acquired by the mission pack acquisition unit 12a are stored in the storage unit 11, and hence processes can be managed in units of mission packs. In this manner, a mission pack intervenes in the association between a process and check items, and hence the number of check items directly associated with a process is reduced. Check items that are redundantly associated with different processes A and B such as the check item B, the check item D, and the check item E illustrated in FIG. 5(a) only need to be associated with the different processes A and B as the same mission pack B as illustrated in FIG. 5(b). As a result, the management of association between a process and check items is facilitated.

For example, by defining and sharing a mission pack for each organization, the mission pack can be applied when defining a mission pack corresponding to processes. For example, a mission pack corresponding to processes different depending on areas can be defined by referring to the definition in other areas and changing only a mission pack different depending on areas without changing the common mission pack. Consequently, check items corresponding to a process can be completely defined with efficiency.

Referring back to FIG. 2, the process set acquisition unit 12b acquires a process set associated with a set of processes. Specifically, the process set acquisition unit 12b acquires the process set information 11c, and stores the process set information 11c in the storage unit 11. For example, the process set acquisition unit 12b receives input of process set information generated in advance from an operator or another device such as the client terminals 30 and 40, and stores the process set information in the storage unit 11.

Alternatively, the process set information 11c may be automatically generated. For example, the management device 10 may store a template of process set information in the storage unit 11, and the process set acquisition unit 12b may generate the process set information 11c on the basis of the template when starting to plan a crisis response.

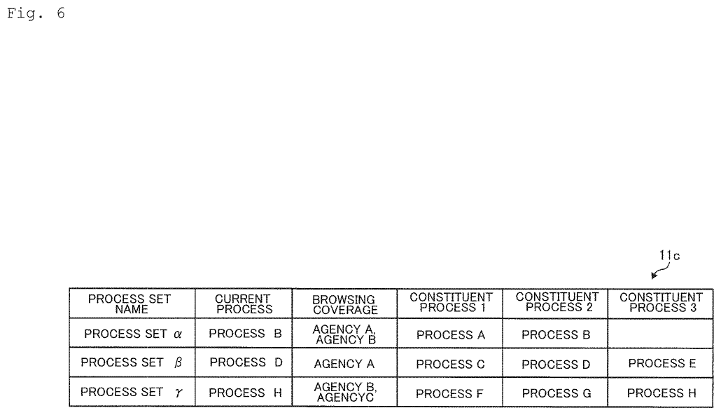

FIG. 6 is a diagram exemplifying a data configuration of the process set information 11c. As illustrated in FIG. 6, the process set information 11c is information indicating a process set associated with a set of processes, and is indicated by association between a process set and processes. In FIG. 6, a process set name indicates the name of a process set. Constituent processes 1, 2, 3, . . . indicate the names of processes associated with each process set. In the example illustrated in FIG. 6, for example, a process set “process set a” is associated with a process “process A” and a “process B”.

Note that items “current process” and “browsing coverage” included in the process set information 11c illustrated in FIG. 6 are described later.

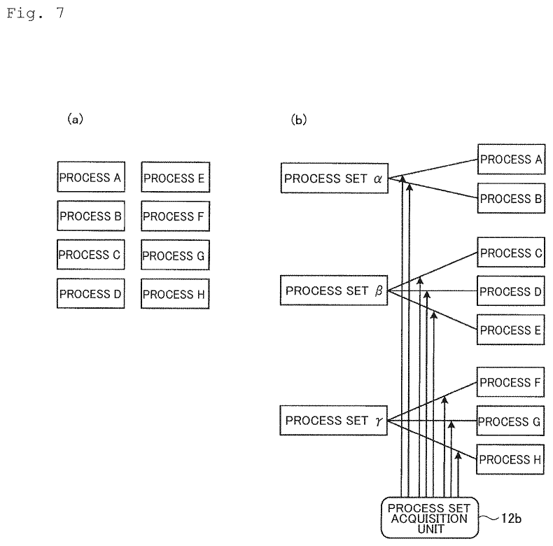

FIG. 7 are explanatory diagrams for describing processing of the process set acquisition unit 12b. Conventionally, a large number of processes are uniformly managed as illustrated in FIG. 7(a). On the other hand, the process set acquisition unit 12b acquires the process set information 11c and stores the process set information 11c in the storage unit 11, and hence as illustrated in FIG. 7(b), the same number of processes as the processes exemplified in FIG. 7(a) can be managed for each process set. Thus, for example, the processing for each process set, such as the display of processes for each process set by switching, can be performed.

For example, processes corresponding to a process set different depending on areas can be defined by referring to the definition of the process sets in other areas and changing only a process different depending on areas without changing the common process set. Consequently, processes constituting a process set can be completely defined with efficiency.

Referring back to FIG. 2, the integration unit 12c integrates, for each process set, the association among a process, a mission pack, and check items as the integrated information 11d. Specifically, the integration unit 12c uses the process information 11a, the mission pack information 11b, and the process set information 11c to generate the integrated information 11d, and stores the integrated information 11d in the storage unit 11.

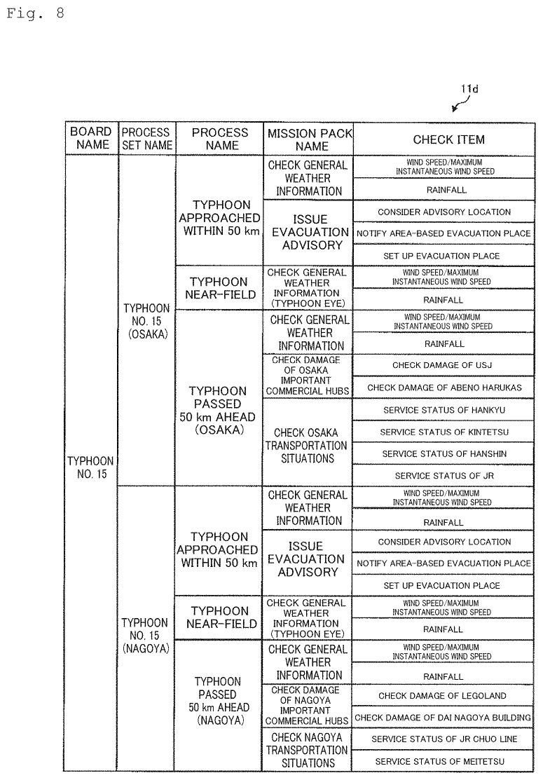

FIG. 8 is a diagram exemplifying a data configuration of the integrated information 11d. FIG. 8 exemplifies integrated information 11d corresponding to two process sets “Typhoon No. 15 (Osaka)” and “Typhoon No. 15 (Nagoya)” whose boards as units of management of critical events are the same “Typhoon No. 15”.

For example, in the example illustrated in FIG. 8, the process set “Typhoon No. 15 (Osaka)” is associated with three processes “Typhoon within 50 km”, “Typhoon near-field”, “Typhoon passed 50 km ahead (Osaka)”. The process “Typhoon within 50 km” is associated with three mission packs “Check general weather information” and “Issue evacuation advisory”. The mission pack “Check general weather information” is associated with two check items “wind speed/maximum instantaneous wind speed” and “rainfall”.

The use of the integrated information 11d enables the process sets “Typhoon No. 15 (Osaka)” and “Typhoon No. 15 (Nagoya)” different depending on areas to be managed within the same board “Typhoon No. 15”, for example.

Note that, in the example illustrated in FIG. 8, the process set “Typhoon No. 15 (Osaka)” is different from the process set “Typhoon No. 15 (Nagoya)” only in the process “Typhoon passed 50 km ahead (Osaka)”, which is different depending on areas. In this manner, the process set acquisition unit 12b can define processes in the process set “Typhoon No. 15 (Osaka)” different depending on areas by, for example, referring to the process set “Typhoon No. 15 (Nagoya)” and changing only the process “Typhoon passed 50 km ahead (Osaka)” different depending on areas. Consequently, the processes in the process set are completely defined with efficiency.

In the example illustrated in FIG. 8, the process “Typhoon passed 50 km ahead (Osaka)” is different from the process “Typhoon passed 50 km ahead (Nagoya)” only in mission packs “Check damage of Osaka important commercial hubs” and “Check Osaka transportation situations”, which are different depending on areas. In this manner, the mission pack acquisition unit 12a can define mission packs in the process “Typhoon passed 50 km ahead (Osaka)” different depending on areas by referring to the process “Typhoon passed 50 km ahead (Nagoya)” in another area and changing only the mission packs “Check damage of Osaka important commercial hubs” and “Check Osaka transportation situations” different depending on areas. Consequently, the mission packs are completely defined with efficiency.

As a result, it is understood that check items corresponding to processes are completely defined with efficiency in the integrated information 11d. In this manner, the processing of the integration unit 12c facilitates the management of check items corresponding to processes.

Referring back to FIG. 2, the current process acquisition unit 12d acquires a current process that is a process currently in progress. Specifically, the current process acquisition unit 12d receives input of information for designating a process currently in progress from an operator or another device such as the client terminals 30 and 40, and stores the process currently in progress in the storage unit 11. For example, the current process acquisition unit 12d registers a process currently in progress in the item “current process” included in the process set information 11c as illustrated in FIG. 6.

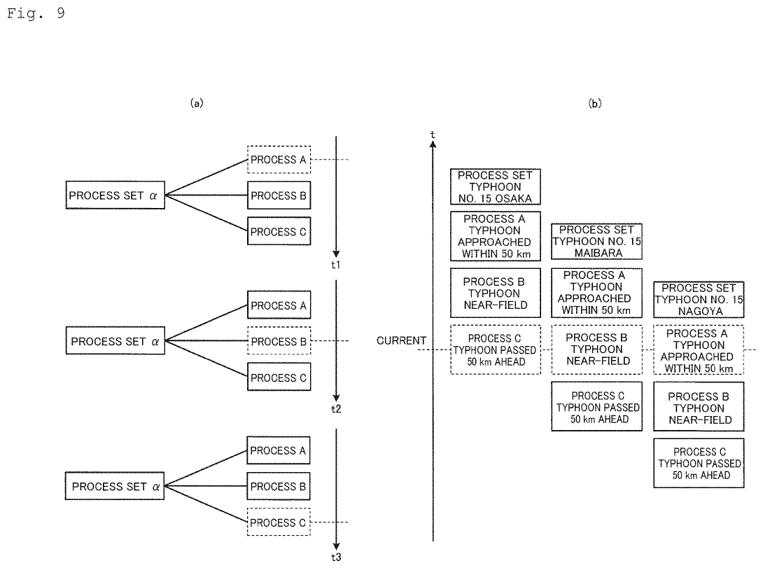

FIG. 9 are explanatory diagrams for describing processing of the current process acquisition unit 12d. In FIG. 9, current processes are surrounded by broken lines. Because the current process acquisition unit 12d acquires current processes, for example, as illustrated in FIG. 9(a), even when a plurality of the same process sets a are in progress concurrently, the process sets a can be managed on different time axes t1 to t3. In this case, for example, the screen display exemplified in FIG. 9(a) can be output to the client terminal 30 for management.

As illustrated in FIG. 9 (b), the progresses of a plurality of process sets that are in progress concurrently can be managed on the same time axis. In the example illustrated in FIG. 9(b), the current times of three process sets “Typhoon No. 15 (Osaka)”, “Typhoon No. 15 (Maibara)”, and “Typhoon No. 15 (Nagoya)” are adjusted such that respective processes are mapped on the same time axis. For example, the screen display exemplified in FIG. 9(b) can be output to the client terminal 30 for management. Consequently, the progresses of a plurality of process sets can be checked on the same time axis.

Referring back to FIG. 2, the browsing coverage acquisition unit 12e acquires, for each process set, a browsing coverage indicating an organization for which browsing is permitted. Specifically, the browsing coverage acquisition unit 12e receives input of information for designating a browsing coverage from an operator or another device such as the client terminals 30 and 40, and stores the browsing coverage in the storage unit 11. For example, the browsing coverage acquisition unit 12e registers an organization name of an organization for which browsing is permitted in the item “browsing coverage” included in the process set information 11c as illustrated in FIG. 6. In the example illustrated in FIG. 6, the browsing coverage of the process set a is the agency A and the agency B.

The disclosure unit 12f refers to the browsing coverage, and in response to a request from the organization for which browsing is permitted, discloses information on processes, mission packs, or check items associated with the process set in the integrated information 11d. For example, when the disclosure unit 12f receives a disclosure request that designates a process set and processes in the integrated information 11d from the client terminal 30, 40, the disclosure unit 12f permits the output of information on the designated processes if the organization of the client terminal 30, 40 is included in the browsing coverage.

In this manner, for example, check items for processes corresponding to the process set “Typhoon No. 15 (Osaka)” in the board “Typhoon No. 15” can be defined by referring to information in the process set “Typhoon No. 15 (Nagoya)” in its own board “Typhoon No. 15” or information in another board “Typhoon No. 14”.

Information on check items for different process sets in a plurality of boards can be aggregated by using Excel (registered trademark) or the like and disclosed.

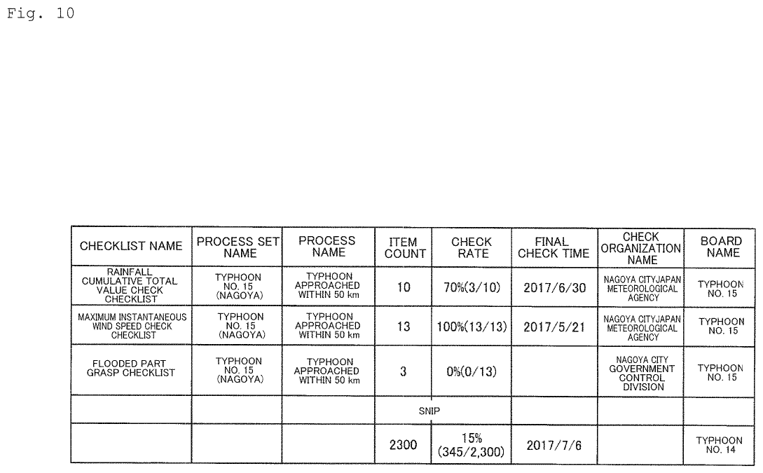

FIG. 10 is an explanatory diagram for describing processing of the disclosure unit 12f. As illustrated in FIG. 10, the disclosure unit 12f can aggregate, for each check item corresponding to a process associated with a process set, information on check items and disclose the results as, for example, a See screen to the client terminal 30, 40 in the organization included in the browsing coverage. The disclosure unit 12f can merge and disclose information on check items in a plurality of boards.

In the example illustrated in FIG. 10, for example, in the process set “Typhoon No. 15 (Nagoya)” in the board “Typhoon No. 15”, information on a checklist “rainfall cumulative total value check checklist” in the check item “rainfall” corresponding to the process “Typhoon within 50 km” is disclosed. Information in the board “Typhoon No. 14” is disclosed as well.

Note that, in FIG. 10, a “checklist name” indicates the name of a checklist indicating specific contents of check items. An “item count” indicates the number of items included in a checklist. A “check rate” indicates the proportion of check finish items to the number of items in a checklist. “Last check time” indicates update time of information. A “check organization name” indicates the name of an organization that executes checking of a checklist.

As described above, the progress of crisis response at the field class can be more easily grasped by the management class. At the field class responsible for a plurality of boards, the progress of each board can be more easily grasped by checking one screen.

Note that, for example, the above-mentioned current process acquisition unit 12d may refer to the “last check time” illustrated in FIG. 10 to detect a process in progress.

[Management Processing]

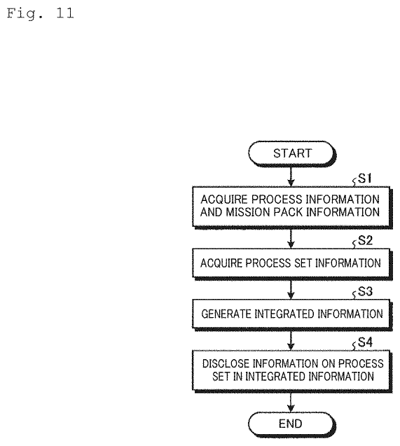

Next, management processing by the management device 10 according to this embodiment is described with reference to FIG. 11. FIG. 11 is a flowchart illustrating a management processing procedure. For example, the flowchart in FIG. 11 is started at timing at which operation to instruct start is input.

First, the mission pack acquisition unit 12a acquires mission pack information 11b, that is, a mission pack associated with a set of check items to be implemented during crisis response. The mission pack acquisition unit 12a acquires process information 11s, that is, association between a process indicating a phase of a critical event and a mission pack (Step S1). For example, the mission pack acquisition unit 12a receives input of process information and mission pack information, and stores the process information and the mission pack information in the storage unit 11.

Next, the process set acquisition unit 12b acquires the process set information 11c, that is, a process set associated with a set of processes (Step S2). For example, the process set acquisition unit 12b receives input of process set information, and stores the process set information in the storage unit 11.

Next, the integration unit 12c integrates, for each process set, the association among a process, a mission pack, and check items as the integrated information 11d. Specifically, the integration unit 12c uses the process information 11a, the mission pack information 11b, and the process set information 11c to generate the integrated information 11d, and stores the integrated information 11d in the storage unit 11 (Step S3).

The disclosure unit 12f uses the integrated information 11d to refer to a browsing coverage for each process set acquired by the browsing coverage acquisition unit 12e, and in response to a request from an organization for which browsing is permitted, discloses information on a process, a mission pack, or check items associated with a process set in the integrated information 11d (Step S4). In this manner, a series of management processing is finished.

As described above, in the management device 10 in this embodiment, the mission pack acquisition unit 12a acquires a mission pack associated with a set of check items to be implemented during crisis response and association between a process indicating a phase of a critical event and the mission pack. The process set acquisition unit 12b acquires a process set associated with a set of processes. The integration unit 12c integrates, for each process set, association among a process, a mission pack, and check items as integrated information 11d.

Consequently, the management of check items corresponding to a process is facilitated. For example, check items corresponding to a process can be completely defined with efficiency. A plurality of process sets can be managed. As a result, crisis can be flexibly and easily dealt with.

The current process acquisition unit 12d acquires a current process that is a process currently in progress. Consequently, a plurality of process set in progress concurrently can be managed on different time axes. Alternatively, the progresses of a plurality of process sets can be checked on the same time axis.

The browsing coverage acquisition unit 12e acquires, for each process set, a browsing coverage indicating an organization for which browsing is permitted. The disclosure unit 12f refers to the browsing coverage, and in response to a request from the organization for which browsing is permitted, discloses information on a process, a mission pack, or check items associated with the process set in the integrated information 11d.

Consequently, the settings and check statuses of a mission pack in another board can be referred to and utilized for operation of the own board. For example, in the case of operation of the board “Typhoon No. 15”, a mission pack or a process set applied to the board “Typhoon No. 14” can be referred to to define a mission pack or a process set. Aggregated information on check items for different process sets in a plurality of boards can be browsed. Consequently, the progress of crisis response at the field class can be more easily grasped by the management class. At the field class responsible for a plurality of boards, the progresses of boards can be more easily grasped by checking one screen.

[Program]

A program in which the processing executed by the management device 10 according to the above-mentioned embodiment is written by a computer-executable language can be created. In one embodiment, the management device 10 can be implemented by installing a management program for executing the above-mentioned management processing as packaged software or online software on a desired computer. For example, by executing the above-mentioned management program by an information processing device, the information processing device can function as the management device 10. The information processing device as used herein includes a desktop or notebook personal computer. In addition, the category of the information processing device includes a mobile communication terminal such as a mobile phone and a slate device such as personal digital assistants (PDA).

The management device 10 can be implemented as a server device for providing a client, which is a terminal device used by a user, with service related to the above-mentioned management processing. For example, the management device 10 is implemented as a server device for providing management processing service that outputs information on processes, mission packs, and check items in response to input for designating a process set. In this case, the management device 10 may be implemented as a Web server, or may be implemented as a cloud for providing service related to the above-mentioned management processing by outsourcing. An example of a computer for executing a management program for implementing the same functions as those of the management device 10 is described below.

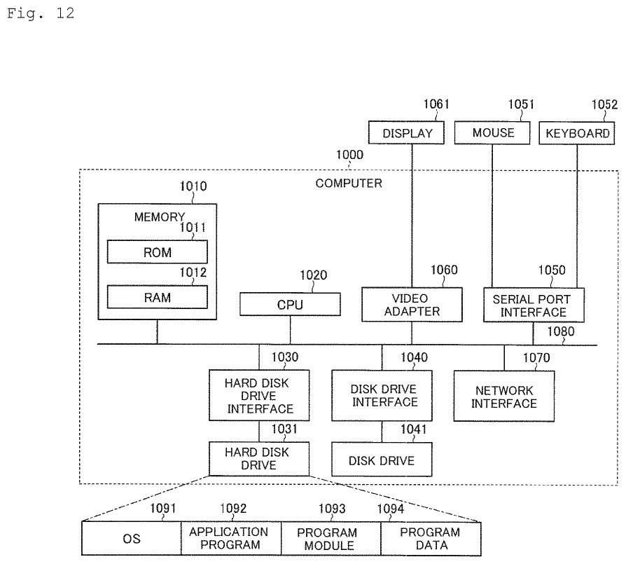

FIG. 12 is a diagram illustrating an example of a computer for executing a management program. For example, a computer 1000 includes a memory 1010, a CPU 1020, a hard disk drive interface 1030, a disk drive interface 1040, a serial port interface 1050, a video adapter 1060, and a network interface 1070. The units are connected by a bus 1080.

The memory 1010 includes a read only memory (ROM) 1011 and a RAM 1012. The ROM 1011 stores therein a boot program such as a basic input output system (BIOS). The hard disk drive interface 1030 is connected to a hard disk drive 1031. The disk drive interface 1040 is connected to a disk drive 1041. A removable storage medium such as a magnetic disk or an optical disc is inserted to the disk drive 1041. For example, the serial port interface 1050 is connected to a mouse 1051 and a keyboard 1052. For example, the video adapter 1060 is connected to a display 1061.

For example, the hard disk drive 1031 stores therein an OS 1091, an application program 1092, a program module 1093, and program data 1094. The pieces of information described in the above-mentioned embodiment are stored in, for example, the hard disk drive 1031 and the memory 1010.

For example, the management program is stored in the hard disk drive 1031 as the program module 1093 in which instructions executed by the computer 1000 are written. Specifically, the program module 1093 in which each piece of processing executed by the management device 10 described in the above-mentioned embodiment is written is stored in the hard disk drive 1031.

Data used for information processing by the management program is stored in, for example, the hard disk drive 1031 as the program data 1094. The CPU 1020 reads the program module 1093 and the program data 1094 stored in the hard disk drive 1031 onto the RAM 1012 as needed, and executes each of the above-mentioned procedures.

Note that the program module 1093 and the program data 1094 for the management program are not necessarily required to be stored in the hard disk drive 1031, and, for example, may be stored in a removable storage medium and read by the CPU 1020 through the disk drive 1041. Alternatively, the program module 1093 and the program data 1094 for the management program may be stored in another computer connected through a network such as a LAN or a wide area network (WAN) and read by the CPU 1020 through the network interface 1070.

While the embodiment to which the invention made by the inventors of the present invention is applied has been described above, the present invention is not limited by the description and drawings constituting a part of the disclosure of the present invention by this embodiment. In other words, other embodiments, examples, and operation technologies that could be conceived by a person skilled in the art based on this embodiment are all included in the scope of the present invention.

### REFERENCE SIGNS LIST

1 Crisis response system
2 Network
3 Operations center
4A, 4B, 4C Agency
10 Management device
11 Storage unit
11a Process information
11b Mission pack information
11c Process set information
11d Integrated information
12 Control unit
12a Mission pack acquisition unit
12b Process set acquisition unit
12c Integration unit
12d Current process acquisition unit
12e View range acquisition unit
12f Disclosure unit
30, 40A, 40B Client terminal

1. A management device, comprising: a mission pack acquisition unit that acquires a mission pack associated with a set of check items to be implemented during crisis response and association between a process indicating a phase of a critical event and the mission pack; a process set acquisition unit that acquires a process set associated with a set of the processes; and an integration unit that integrates, for each process set, association among the process, the mission pack, and the check items as integrated information.

2. A management device, comprising: a storage unit that stores therein mission pack information which is a set of mission packs associated with a set of check items to be implemented during crisis response, and process information which is association between a process indicating a phase of a critical event and the mission pack; a mission pack acquisition unit that acquires a set of check items associated with the mission pack and a mission pack associated with the process from the storage unit; and an integration unit that integrates association among the process, the mission pack, and the check items as integrated information.

3. A management device, comprising: a storage unit that stores therein a process set associated with a set of processes indicating phases of a critical event; a process set acquisition unit that acquires a set of processes associated with the process set from the storage unit; and an integration unit that integrates, for each process set, association between the process and check items to be implemented during crisis response as integrated information.

4. The management device according to claim 1, further comprising a current process acquisition unit that acquires a current process that is a process currently in progress.

5. The management device according to claim 1, further comprising: a browsing coverage acquisition unit that acquires, for each process set, a browsing coverage indicating an organization for which browsing is permitted; and a disclosure unit that refers to the browsing coverage and, in response to a request from the organization for which browsing is permitted, disclosing information on a process, a mission pack, or check items associated with the process set in the integrated information.

6-11. (canceled)
